(19) United States
(12) Patent Application Publication
(10) Pub. No.: US 2026/0049618 A1
(43) Pub. Date: Feb. 19, 2026

(54) RECOVERED-CYCLE AIRCRAFT TURBINE ENGINE

(71) Applicant: SAFRAN HELICOPTER ENGINES, Bordes (FR)

(72) Inventors: Alexandre AUDUBERTEAU, Moissy-Cramayel (FR); Lionel SCUILLER, Moissy-Cramayel (FR); Alphonse PUERTO, Moissy-Cramayel (FR)

(21) Appl. No.: 19/102,305

(22) PCT Filed: Aug. 3, 2023
(86) PCT No.: PCT/FR2023/051234

§ 371 Date: Feb. 7, 2025

(30) Foreign Application Priority Data
Aug. 10, 2022 (FR) 2208231

(51) Int. Cl. F04D 29/44; F04D 25/02; F04D 29/58

(52) U.S. Cl. CPC F04D 29/444; F04D 25/024; F04D 29/5826; F05D 2250/50; F05D 2260/213

(57) ABSTRACT

An aircraft turbine engine having a compressor,—an annular combustion chamber, a system for diffusing and straightening an air stream exiting the compressor in order to supply the combustion chamber, and a heat exchanger, this heat exchanger having: a first circuit supplied with exhaust gas from the turbine engine, and a second circuit comprising an inlet (38ba) connected by a first scroll to an outlet of the diffuser, and an outlet connected by a second scroll to an inlet of the straightener, the scrolls including connecting arms that rigidly connect the annular portions of the scrolls which are secured or connected to the diffuser and to the straightener, respectively.

### TECHNICAL FIELD OF THE INVENTION

The present invention relates to an aircraft turbine engine equipped with a volute assembly for the implementation of a recovered cycle.

### TECHNICAL BACKGROUND

An aircraft turbine engine comprises a gas generator comprising, from upstream to downstream in the flow orientation of the gases, at least one compressor, an annular combustion chamber, and at least one turbine. The compressor is supplied with air and compresses it. The compressed air is mixed with fuel and burned in the combustion chamber, which supplies combustion gases to the turbine. These combustion gases expand in the turbine and rotate its rotor, which in turn drives the rotor of the compressor by means of a common shaft.

A turbine engine may be equipped with one or more bodies, each comprising a compressor rotor connected by a shaft to a turbine rotor.

There are also turbine engines where a free turbine is mounted downstream of the turbine engine bodies. A turbine is free as long as its rotor is not connected by a shaft to a compressor rotor.

It is thus understood that a turbine engine may comprise several successive compressors (for example, a low-pressure compressor followed by a high-pressure compressor), as well as several successive turbines (e.g. a high-pressure turbine followed by a free turbine or a low-pressure turbine).

In this application, a conventional cycle turbine engine means turbine engine in which the compressed air exiting the compressor(s) supplies directly into the combustion chamber.

On the other hand, a recovered-cycle turbine engine is a turbine engine in which the combustion gases flowing out of the turbine or turbines are used to heat the compressed air exiting the compressor(s) and intended to supply the combustion chamber. This technology allows to improve the performance of the turbine engine because the amount of fuel required to reach the operating temperature of the turbine engine is less than that required in the scope of a conventional cycle turbine engine.

FIG. 1 shows a very schematic representation of a recovered-cycle turbine engine.

The turbine engine 1 comprises from upstream to downstream a compressor 2, an annular combustion chamber 3, a turbine 4 and a free turbine 5. The rotors of the compressor 3 and the turbine 4 are connected together by a shaft 6 and form a single body.

The turbine engine 1 comprises a heat exchanger 7, a first circuit of which is supplied with combustion gases collected from the outlet of the free turbine 5. The exchanger 7 comprises a second circuit which is supplied with compressed air exiting the compressor 2 and which supplies heated compressed air to the combustion chamber 3.

The integration of this technology can be complicated when the compressor 2 is a centrifugal type. A centrifugal compressor is a compressor that has an inlet oriented parallel to the longitudinal axis of the turbine engine, and an outlet that is oriented radially with respect to this axis. This type of compressor is associated with a system of diffusion and straightening of the compressed air stream. This system comprises a diffuser-straightener assembly and thus comprises an annular diffuser that is substantially radially oriented and aligned with the outlet of the centrifugal compressor, and an annular straightener that is substantially axially oriented to direct the compressed air stream towards the combustion chamber.

An integration solution for this technology has been proposed in the past and consists of using an assembly of two volutes.

A volute is a duct that is wound spirally around an axis and whose fluid passage cross-section evolves. In the scope of the present application, a volute comprises an annular duct wound around the longitudinal axis of the turbine engine and connected to a first port located at the external periphery of the duct and oriented in a tangential direction, and a second port located at the internal periphery of the duct and oriented in a radial direction.

A first volute has its second port connected to the outlet of the diffuser and its first port supplying the inlet of the second circuit of the exchanger. The outlet of this second circuit is connected to the first port of the second volute, the second port of which is connected to the inlet of the straightener.

The solution proposed in the past is to first interlock the volutes, from their first ports, which are paired, to the circumferential ends of the smallest cross-section of the ducts. The solution is also to move the volutes as close as possible to the centrifugal compressor and the combustion chamber.

In the document FR-A1-3 111 666, the Applicant has already proposed volutes configured and arranged to optimize their size while limiting heat exchange between the fluids circulating in their ducts. The volutes are also designed to facilitate their integration into the turbine engine while limiting the impact on the latter, i.e. limiting structural modifications to it.

In the current technology, the volutes are attached to the casings of the turbine engine by mounting flange. The volutes are connected to a first upstream flange attached to a compressor casing, and to a second downstream flange attached to a casing of the combustion chamber.

The forces transmitted along the turbine engine are therefore transmitted through the volutes, which must therefore have a structural function, i.e. a function of transmitting structural forces. In addition, the pressure within the volutes results in additional stress.

The current geometry of the volutes does not allow for the transfer of structural forces, and there is a risk that the volutes will “open up”, resulting in:
the inability to produce a volute configuration compatible with the forces present in normal operation, which would lead to short service life of the volutes and the appearance of cracks therein in normal operation, or to ruin of the volutes under ultimate forces;
deformations of the volutes (greater than several millimetres) propagated to the casings and leading to a deterioration in the rotor/stator clearances within the turbine engine, synonymous with degraded performance.

Solutions to these problems have already been proposed, such as equipping the volutes with screwed tie rods. However, these solutions are not ideal, particularly as they impact on the airtightness of the assembly and degrade aerodynamic performance by introducing shapes that are not aerodynamically optimal.

The present invention offers a simple, effective and economical solution to the above problems.

### SUMMARY OF THE INVENTION

The invention relates to an aircraft turbine engine, comprising:
a compressor extending around an axis,
an annular combustion chamber extending around the axis,
a system for diffusing and straightening an air stream exiting the compressor to supply the combustion chamber, this system comprising:
an annular diffuser comprising a substantially radially oriented outlet and an inlet supplied by the compressor, and
an annular straightener which comprises an outlet for supplying the combustion chamber, and
a heat exchanger, this exchanger comprising:
   + a first circuit supplied with exhaust gas from the turbine engine, and
   + a second circuit comprising an inlet connected by a first volute to the outlet of the diffuser, and an outlet connected by a second volute to an inlet of the straightener, the first and second volutes being placed side by side and each comprising an annular duct wound around the axis A and connected to a first port located at the external periphery of the duct and oriented in the tangential direction, and a second port located at the internal periphery of the duct and defining an annular vein of air passage,
characterised in that the second port of each of the first and second volutes comprises connecting arms distributed around the axis, these connecting arms extending axially and/or radially through the vein of the second port and rigidly connecting annular portions of the first and second volutes which are attached or connected respectively to the diffuser and the straightener.

The invention thus enables structural forces to be transmitted through the volutes via the connecting arms. The connecting arms ensure the transmission of forces between the annular portion of the volutes that is attached or connected to the straightener or to the first casing, and the annular portion of the volutes that is attached or connected to the diffuser or to the second casing. These connecting arms are advantageously located in the second ports and therefore outside the air passage cross-section in the ducts.

The turbine engine according to the invention may comprise one or more of the following steps or characteristics, considered independently or in combination with each other:
the compressor is a centrifugal, axial or mixed compressor,
   the first volute comprises an upstream annular portion for attachment to the diffuser and/or to a first casing of the turbine engine, this upstream portion defining part of the duct and of the second port of this volute, first connecting arms extending axially through the vein of the second port of this volute from this upstream annular portion,
   the upstream annular portion of the first volute comprises an annular flange, for example radially internal, for attachment to the diffuser and/or the first casing, for example by screw-type elements,
   the first and second volutes share an intermediate annular portion which defines part of the duct and second port of each volute, said first connecting arms extending axially through the vein of the second port of the first volute to this intermediate annular portion,
   the intermediate annular portion comprises air passage channels which are distributed around the axis and which each comprise a first end opening into the first volute, and a second end opening downstream of the diffuser, preferably in the vicinity of the combustion chamber,
   the air passage channels are inclined from upstream to downstream radially inwards with respect to the axis, and are at least partly surrounded by the second volute,
   the second volute comprises a downstream annular portion for attachment to the straightener and/or to a second casing of the turbine engine, this downstream portion defining part of the duct and the second port of this volute,
   the downstream annular portion of the second volute comprises an annular flange for attachment to the diffuser and/or the second casing, by screw-type elements for example,
   second connecting arms extend axially through the second port of the second volute from the intermediate portion to the downstream portion,
   the intermediate and downstream portions are formed in a single piece with the straightener, of the vanes of this straightener forming second connecting arms between these portions,
   the parts of the ducts defined by said annular portions have greater thicknesses than the rest of these ducts,
   said annular portions are all formed in a single piece,
   the number of connecting arms for each of the second ports is between 6 and 60, and preferably between 8 and 20,
the connecting arms are evenly distributed around the axis,
the connecting arms have aerodynamic profiles,
the connecting arms in the vein of the second port of the first volute are aligned with the vanes of the diffuser,
the number of connecting arms in the vein of the second port of the first volute is a sub-multiple of the number of vanes of the diffuser,
the connecting arms in the vein of the second port of the second volute are aligned with the vanes of the straightener,
the number of connecting arms in the vein of the second port of the second volute is a sub-multiple of the number of vanes of the straightener,
the diffuser is angled,
the duct of each of the volutes has an evolving passage cross-section which is at its maximum at the first port and at its minimum at a circumferential end of the duct opposite the first port,
the volutes have reversed winding directions so that their first ports are formed by parts of ducts spaced apart from each other and the minimum section of each duct is located at the level of a larger section of the other duct,
each of the volutes has circular or oval-shaped passage cross-section extending over an angle of at least 220°,
the passage cross-section of the first volute is not nested in the passage cross-section of the other volute.

### BRIEF DESCRIPTION OF THE FIGURES

Further characteristics and advantages of the invention will become apparent from the following detailed description, for the understanding of which reference is made to the attached drawings wherein:

FIG. 1 is a very schematic view of a recovered-cycle aircraft turbine engine;

FIG. 2 is a partial schematic view of a recovered-cycle aircraft turbine engine in axial section;

FIG. 3 is a schematic perspective view of a volute assembly from the turbine engine in FIG. 2;

FIG. 4 is a schematic axial sectional view of the volute assembly in FIG. 3;

FIG. 5 is a partial schematic view in axial cross-section of a recovered-cycle aircraft turbine engine, according to a first embodiment of the invention;

FIG. 6 is a schematic perspective view of the turbine engine shown in FIG. 5;

FIG. 7 is a partial schematic view in axial section of a recovered-cycle aircraft turbine engine, according to a second embodiment of the invention; and

FIG. 8 is a schematic axial section perspective view of the turbine engine shown in FIG. 7.

### DETAILED DESCRIPTION OF THE INVENTION

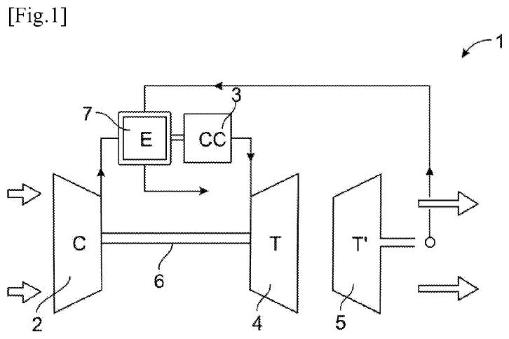

FIG. 1 has already been described above.

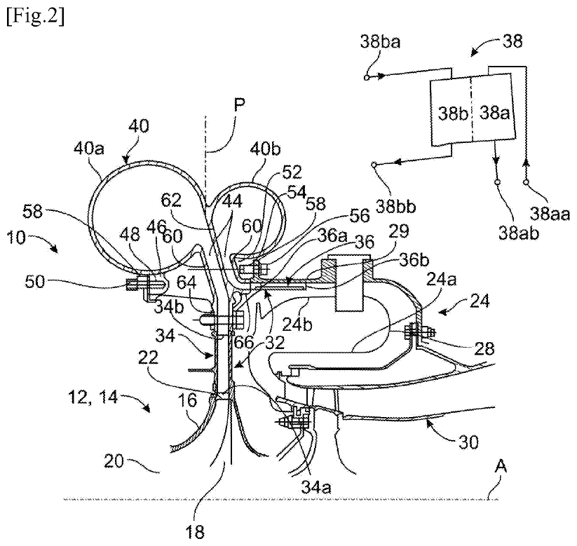

FIGS. 2 to 4 illustrate an aircraft turbine engine 10.

The turbine engine 10 is partially shown in FIG. 1 and conventionally comprises at least one compressor, an annular combustion chamber and at least one turbine.

In the example shown, the turbine engine 10 comprises one or two successive compressors 12, 14 which are therefore attached one after the other and which may both be of the centrifugal type.

The compressors 12, 14 are annular in shape and are coaxial and centered on an axis A which is the longitudinal axis of the turbine engine 10. Each compressor 12, 14 comprises a stator 16 and a bladed rotor 18, referred to as impeller, which rotates within the stator 16 and about the axis A.

In the example shown, each compressor 12, 14 comprises an inlet 20 oriented axially upstream and an outlet 22 oriented radially outwards with respect to axis A. The expressions upstream and downstream refer here to the general flow of air and gases in the turbine engine 10.

The compressor 14 is thus located downstream of the compressor 12.

Alternatively, the turbine engine 10 could comprise a single compressor, not necessarily of the centrifugal type. For example, the diffuser can be angled to transform the axial flow at the outlet of an axial compressor into a radial flow as on a centrifugal compressor or any compressor configuration intermediate between centrifugal and axial.

The turbine engine 10 in FIG. 2 further comprises a combustion chamber 24 which is located downstream of the compressor 14.

A combustion chamber 24 comprises two annular walls, respectively internal 24a, and external 24b, which define between them an annular cavity into which compressed air from the compressor 14 and fuel from injectors 26 are injected and mixed.

The walls 24a, 24b are connected to each other by a chamber bottom 28 which is annular in shape and comprises orifices (not visible) for the passage of compressed air from the compressor 14 to supply the chamber 24.

The combustion chamber 24 is surrounded by an external annular casing 29 which carries the injectors 26 in particular.

In the example shown, the chamber 24 is of the inverted type as its chamber bottom 28 is located on the downstream side of this chamber. The outlet of the chamber 24 is located on the upstream side of the chamber and is connected to one or more turbines 30 located downstream of the chamber.

The combustion gases injected into the turbine 30 expand and drive its rotor, which is connected by a shaft to the rotor 18 of at least one of the compressors 12, 14 in order to drive them in rotation about the axis A.

The combustion gases are then evacuated into an exhaust nozzle of the combustion gases which is not shown.

In a conventional cycle turbine engine 10, the connection from the outlet of the compressor 14 to the combustion chamber 24 is carried out by an air diffusing and straightening system 32, also referred to as a diffuser-straightener.

This system 32 comprises:
an annular diffuser 34 which is oriented substantially radially, and which comprises at its internal periphery an inlet 34a supplied by the compressor 14 and aligned radially with the outlet 22 thereof, and an outlet 34b at its external periphery which opens radially outwards; and
an annular straightener 36 which is substantially axially oriented in the example shown and which comprises at its upstream end an inlet 36a, and at its downstream end an outlet 36b for supplying the combustion chamber 24.

The diffuser 34 is located upstream of the chamber 24 and its walls 24a, 24b and the straightener 36 extends around the chamber 24 and its walls 24a, 24b and inside of the casing 29. The diffuser 34 may be clamped to the stator 16 of the compressor 12 and/or the compressor 14. The straightener 36 can be clamped to the casing 29.

The diffuser 34 and the straightener 36 can be bladed.

In a conventional cycle turbine engine 10, the outlet 34b of the diffuser 34 is directly connected, for example by an L-bend duct to the inlet 36a of the straightener 36. Alternatively, the compressed air exiting the compressor 14 supply directly the combustion chamber 24.

According to the invention, the turbine engine 10 is of the recovered-cycle type which means that the compressed air exiting the compressor 14 is heated before being injected into the combustion chamber 24.

The compressed air is heated by means of a heat exchanger 38 on the one hand and an assembly of two volutes 40 on the other.

The heat exchanger 38 is schematically shown and essentially comprises two circuits 38a, 38b, namely:
a first circuit 38a, an inlet 38aa of which is connected to means for collecting exhaust gases from the outlet of the turbines 30 or from the aforementioned exhaust nozzle, and an outlet 38ab which can also be connected to the exhaust nozzle for the purpose of releasing these gases into the atmosphere, and
a second circuit 38b comprising an inlet 38ba and an outlet 38bb connected to the volute assembly 40.

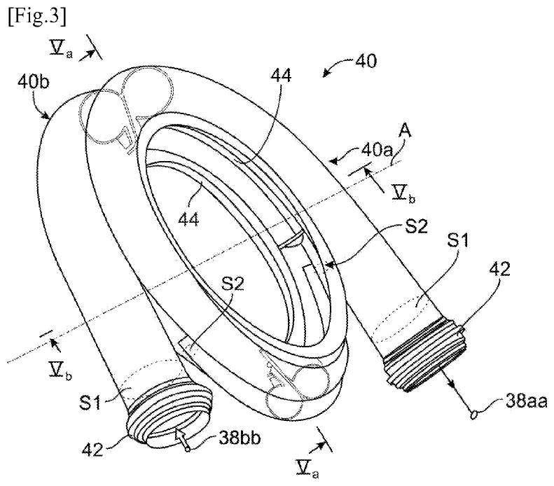

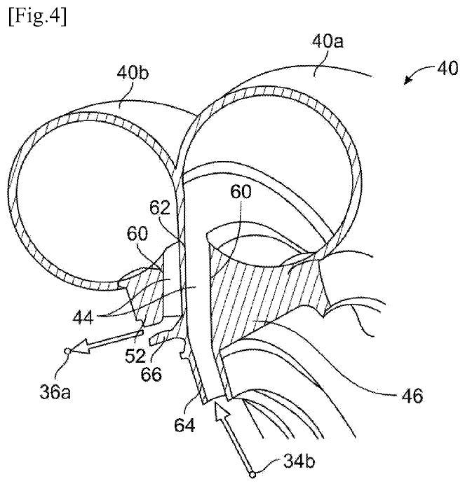

The volute assembly 40 is shown in its entirety in FIG. 3 and in cross-section in FIGS. 2 and 4.

The assembly 40 comprises two volutes 40a, 40b, which are in this case joined together and coaxial.

Each volute 40a, 40b comprises a duct wound in a spiral around an axis which is here the axis A, preferably over at least 360° so that the duct makes at least one revolution on itself.

Each volute 40a, 40b comprises a first port 42 located at the external periphery of the duct and oriented in a tangential direction, and a second port 44 of annular shape located at the internal periphery of the duct and oriented in a substantially radial direction.

The cross-sectional area of the duct can change around its circumference, preferably gradually. The passage cross-section is maximum S1 at the level of the first port 42 of each volute 40a, 40b and minimum S2 at the level of the circumferential end of the duct opposite the first port 42.

The volute assembly 40 is connected to the diffuser 34, the straightener 36 and the exchanger 38 as follows. The volute 40a has its second port 44 connected to the outlet 34b of the diffuser 34 and its first port 42 supplying the inlet 38ba of the second circuit 38b of the exchanger 38. The outlet 38bb of this second circuit 38b is connected to the first port 42 of the second volute 40b, the second port 44 of which is connected to the inlet 36a of the straightener 36.

In the example shown, the volute 40a is located upstream of the volute 40b. The volutes 40a, 40b each have a circular or oval passage cross-section, preferably over their entire circumferential extent. By oval shape, it is understood any elliptical, ovoid or oblong shape. However, other forms are possible.

The volutes 40a, 40b are joined together and preferably not nested in each other so as to limit the thermal exchanges between the air stream circulating simultaneously in the two volutes. This means that the passage cross-section of one volute does not overlap with the passage cross-section of the other volute. In this case, this means that the passage cross-section of each volute is almost complete through 360°. For example, it is perfectly circular or almost perfectly circular in the case of a circular passage cross-section. This angle is at least 220° and preferably as close to 360° as possible.

In addition, the volutes 40a, 40b extend around and away from the casing 29 and are clamped to the latter, as will be detailed below.

The plane P is defined as a plane of junction of the volutes 40a, 40b, this plane passing between the volutes and being perpendicular to the axis A. The plane P here extends just upstream of the diffuser 34.

The duct of each volute 40a, 40b comprises an annular skin which defines the aforementioned passage cross-section, and which has a substantially constant thickness, both over its circumferential extent around the axis A and also over its entire extent when considering an axial cross-section of the duct, as seen in FIG. 2 for example.

As can be seen more clearly in the figure, a first annular boss 46 is located at the internal periphery of the volute 40a and comprises blind and threaded screw holes 48 for screws 50. A second annular boss 52 is located at the internal periphery of the volute 40b and comprises blind and threaded screw holes 54 for screws 56. The bosses 46, 50 are applied against annular flanges 58 of the casing 29 or another external casing of the turbine engine, these flanges 58 comprising passage orifices for the screws 50, 56. The screws 50, 56 are axially oriented and evenly spaced around the axis A. The volutes 40a, 40b are thus attached by clamping.

The volutes 40a, 40b have reversed winding directions so that their ports 42 are formed by spaced apart duct portions.

The ports 42 are independent of each other and are spaced apart and for example substantially diametrically opposite each other with respect to the axis A.

Thus, the minimum cross-section S2 of each duct is located at the level of a larger cross-section of the other duct. The maximum cross-section S1 of each duct is located at the level of a smaller cross-section of the other duct. This can be seen in FIG. 3 in particular.

As can also be seen in FIG. 3, the ports 42 are each generally tubular in shape and are coupled to the inlet 38ba and outlet 38bb of the exchanger 38 respectively by suitable means.

The second port 44 of each volute 40a, 40b comprises two annular walls 60, 62 extending around the axis A and defining an air passage vein between them.

The walls 60, 62 are substantially parallel and project radially inwards from the junction plane P of the volutes and from the annular skins of the volutes. In the example shown, the walls 60, 62 are frustoconical and converge from upstream to downstream radially inwards. The walls 60, 62 are therefore inclined with respect to the plane P.

In the example shown, the volute assembly 40 is formed in a single piece. The volutes 40a, 40b and their ports 42, 44 are thus formed in a single piece.

In the case shown, this means that the walls 62 of the two ports 44 are merged.

The walls 60, 62 of the volute 40a have free ends opposite the duct, which define a substantially radially oriented connector 64 to the outlet 34b of the diffuser 34. This connector 64 is annular in shape and may be attached by screws or the like to the casing 29 or another casing of the turbine engine.

The walls 60, 62 of the volute 40b have free ends opposite the duct, which define a substantially axially oriented connector 66 for connection to the inlet 36a of the straightener 36. This connector 66 is annular in shape and can be joined to the boss 52 and attached by means of this boss to the casing 29.

In the example shown, the walls 60, 62 have a similar or identical thickness to the skins of the ducts.

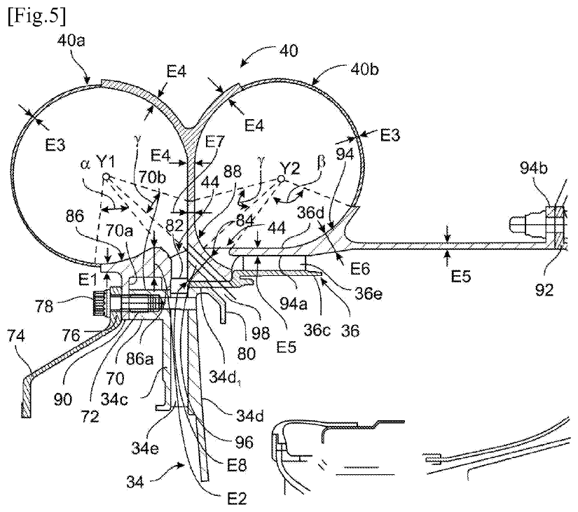

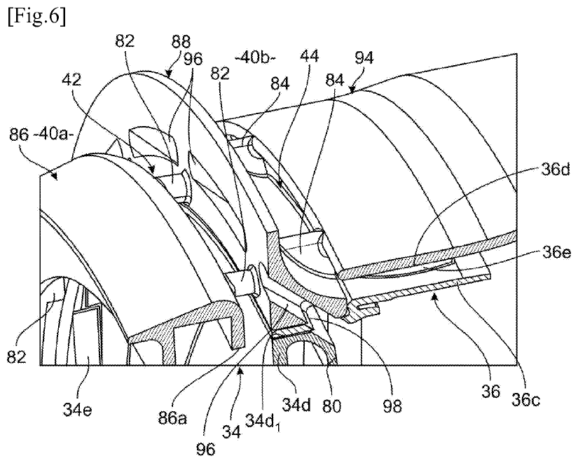

FIGS. 5 and 6 illustrate a first embodiment of the invention.

The turbine engine 1 of this first embodiment includes all the characteristics described above in relation to FIGS. 1 to 4 insofar as they do not conflict with the following description. These characteristics are designated by the same reference numbers.

The diffuser 34 comprises two annular walls 34c, 34d extending around the longitudinal axis A of the turbine engine 1. These walls 34c, 34d are oriented radially with respect to this axis A and are respectively upstream and downstream the walls. These walls 34c, 34d are connected to each other by vanes 34e and define between them an air passage vein which is also radially oriented.

The upstream wall 34e has a cylindrical rim at its external periphery 70 facing upstream. This rim 70 comprises an external cylindrical surface 70a and an upstream radial surface 70b. Threaded orifices 72 are formed in this rim 70 and open onto the upstream radial surface 70b.

An annular casing 74, such as a compressor casing, comprises a downstream annular flange 76 which is applied against the upstream radial surface 70b and which is attached to the rim 70 and to the diffuser 34 by mounting elements 78 which 20 are screws. The screws pass through orifices in the flange 76 and are screwed into tapped orifices 72 in the rim 70.

The downstream wall 34d has an external cylindrical surface 34d1 at its external periphery. It also has an annular lug at its periphery 80, the upstream end of which is connected to the downstream wall 34d and the downstream end 25 of which is free and has a radial orientation.

The external cylindrical surfaces 70b, 34e1 have approximately the same diameter.

The straightener 36 comprises two annular walls 36c, 36d extending around the longitudinal axis A of the turbine engine 1. These walls 36c, 36d have a generally cylindrical or frustoconical shape and are respectively internal wall 36c and external wall 36d as they extend one inside the other. These walls 36c, 36d define between them an axially oriented air passage vein in which vanes 36e are located.

In the example shown, the external wall 36d is integrated with the second volute 40b or at least the second volute 40b forms the external wall of the straightener 36.

The vanes 36e are formed in a single piece with the internal wall 36c and are therefore connected to the internal wall 36c at their radially internal ends. The radially external ends of the vanes 36e are surrounded by the second volute 40b and can be rigidly connected to it. The internal wall 36c has an upstream portion which is applied radially against the external surface 34d1 of the downstream wall 34d of the diffuser 34, and which is intended to be interposed between this surface 34d1 and the volute assembly 40.

The volute assembly 40 in this embodiment differs from that in the previous embodiment, in particular by the presence of connecting arms 82, 84 at the second ports 44 of the volutes 40a, 40b.

In the first embodiment, first connecting arms 82 extend in the axial direction through the air passage vein of the second port 44 of the first volute 40a, from an upstream annular portion 86 of the first volute 40a to an intermediate annular portion 88 which is common to the two volutes 40a, 40b.

The connecting arms 82 preferably have an aerodynamic profile. In the example shown, they each have a radially internal leading edge and a radially external trailing edge. The leading edge has an orientation parallel to the longitudinal axis A of the turbine engine, while the trailing edge has an inclined orientation in the example shown.

The number of arms 82 is between 6 and 60, for example between 8 and 20. The number of arms 82 may be a sub-multiple of the number of vanes 34e of the diffuser 34.

The arms 82 are preferably evenly spaced around the axis A. They can be aligned radially with the vanes of the diffuser 34.

The upstream annular portion 86 of the first volute 40a is a structural part of the first volute 40a and the volute assembly 40 and is therefore configured to transmit and resist structural forces in operation.

The upstream portion 86 has a minimum thickness E1 and a maximum thickness E2 of material. These thicknesses are measured in a radial direction, for example.

The upstream portion 86 defines part of the second port 44 of the upstream volute 40a, and in particular the upstream wall of this second port 44, and also defines part of the duct of this volute 40a. As can be seen in FIG. 5, for a particular cross-section of the duct which has a circular shape around an axis Y1 (perpendicular to the cutting plane), the upstream portion 86 defines between 5 and 20° (angle α) of the duct around this axis Y1.

The upstream portion 86 comprises an internal cylindrical surface 86a bearing radially against the external cylindrical surface 70b of the diffuser 34. The structural part of the volute 40a is therefore pressed directly against the diffuser 34.

The upstream portion 86 comprises an internal annular flange 90 which is attached to the diffuser 34. In the example shown, the flange 90 is inserted between the flange 76 and the surface 70a of the diffuser 34. This flange 90 comprises axial orifices for the passage of the aforementioned elements 78.

When we look at the duct of the first volute 40a in FIG. 5, we see that the thickness E1 is greater than or equal to the rest of the thickness E3, E4 of the duct, and that the thickness E2 is greater than the thickness E3, E4. In the example shown, it can be seen, for example, that the skin of the duct, which extends from the upstream end of the upstream portion 86 to the diametrically opposite side with respect to the axis Y1, has a small thickness, E3.

The skin extending over the last part of the duct has a thickness E4 slightly greater than E3. Viewed in cross-section, it can be seen that in the area where the duct skins meet, these skins form a Y shape and have this slight extra thickness E4.

Second connecting arms 84 extend axially and radially through the air passage vein of the second port 44 of the second volute 40b, from the intermediate annular portion 88 of the first volute 40a to a downstream annular portion 94 of the second volute 40b.

The connecting arms 84 preferably have an aerodynamic profile. In the example shown, they each have a radially external leading edge and a radially internal trailing edge. The leading edge has an orientation parallel to the longitudinal axis A of the turbine engine 1, while the trailing edge has an inclined orientation in the example shown.

The number of arms 84 is, for example, between 8 and 20. The number of arms 84 may be a sub-multiple of the number of vanes 36e of the straightener 36. The arms 84 are preferably evenly spaced around the axis A. They may be axially aligned with vanes 36e of the straightener 36.

The downstream annular portion 94 is a structural part of the second volute 40b and is therefore configured to transmit structural forces during operation and to withstand these forces.

The downstream portion 94 has a minimum thickness E5 and a maximum thickness E6 of material. These thicknesses are measured in a radial or substantially radial direction.

The downstream portion 94 defines part of the second port 44 of the downstream volute 40b, and in particular the downstream or external wall of this second port 44 and also defines part of the duct of this volute 40b. As can be seen in FIG. 5, for a particular cross-section of the duct which has a circular shape around an axis Y2 (perpendicular to the cutting plane), the downstream portion 84 defines between 10 and 30° (angle β) of the duct around this axis Y2.

The downstream portion 94 comprises an internal cylindrical surface 94a for radial support on the radially external ends of the vanes 36e of the straightener 36, or for connection to the vanes 36e of the straightener 36. The structural part of the volute 40b is therefore pressed directly against the straightener 36.

The downstream portion 94 comprises a downstream extension which terminates in an annular mounting flange 94b.

An annular casing 92, such as a combustion chamber casing, comprises an upstream annular flange which is attached to the flange 94b by fastening elements, in this case screws.

When we look at the duct of the second volute 40b in FIG. 5, we see that the thickness E5 is greater than or equal to the rest of the thickness E3, E4 of the duct, and that the thickness E6 is greater than the thickness E3, E4.

In the example shown, it can be seen, for example, that the skin of the duct, which extends between the portion 94 and the aforementioned Y part, has a small thickness E3.

The intermediate portion 88 is located between portions 86 and 94 and is connected to arms 82 and 84 respectively.

This intermediate portion 88 is also a structural part of the volutes 40a, 40b and is therefore configured to transmit structural forces during operation and to withstand these forces.

In the example shown, the intermediate portion 88 has a minimum thickness E7 and a maximum thickness E8 of material.

Preferably, E1, E5 and E7 are identical or close to each other (within +/−10%).

Preferably, E2, E6 and E8 are identical or close to each other (within +/−10%).

The intermediate portion 88 defines part of the second port 44 of each downstream volute 40a, 40b, and in particular the downstream wall of the second port 44 of the first volute 40a, and the upstream wall of the second port 44 of the second volute 40b.

The intermediate portion 88 also defines part of the duct of the volutes 40a, 40b. As can be seen in FIG. 5, for a particular cross-section of each duct which has a circular shape around the axis Y1, Y2, the intermediate portion 88 defines between 5 and 10° (angle γ) of the duct around this axis Y1, Y2.

The intermediate portion 88 comprises an internal cylindrical surface 88a bearing radially on the upstream end of the wall 36c of the straightener, which is thus clamped radially between the portion 88 and the surface 34d1 of the diffuser 34.

The common structural part of the volutes 40a, 40b is therefore applied against the diffuser 34 and the straightener 36.

The intermediate portion 88 may comprise air passage channels 96 which are distributed around the axis A and which each comprise a first end opening into the duct of the first volute 40, and a second end opening downstream of the diffuser 34 and radially inside the straightener 36 and in particular its internal wall 36c.

As can be seen in FIG. 5, the channels 96 are aligned with orifices 98 formed in the wall 36c for the passage of air exiting the channels 96.

In the example shown, these channels 96 are inclined radially inwards from upstream to downstream with respect to the axis A, and are at least partly surrounded by the second volute 40b.

The aforementioned lug 80 preferably has a frustoconical portion which extends parallel to the general orientation of the channels 96 to guide the air exiting these channels.

Preferably, this air is used to cool components of a turbine engine turbine, such as the nozzle and the high-pressure turbine ring. Typically, in an architecture without an exchanger, the air entering the combustion chamber serves as a cold source for cooling the turbine components. With an exchanger, the air heated by the exchanger and arriving in the chamber can become too hot for adequate cooling of these components. It is therefore useful to have a cold source upstream of the exchanger.

The arrangement of air intake channels 96 at the inlet to volute 40a allows a sufficiently low temperature and sufficiently high static pressure to be combined at the intake to supply the cooling circuit for the turbine components.

In this embodiment, the annular portions 86, 88, 94 are preferably formed in a single piece with the arms 82, 84. The other parts of the volutes 40a, 40b and the ducts can be attached and welded or brazed to this part, for example. This is the case, for example, with the Y-shaped part of the skins mentioned above.

In this embodiment, the portions 86, 88 and 94 are made independently of the straightener 36, which is formed by a separate part.

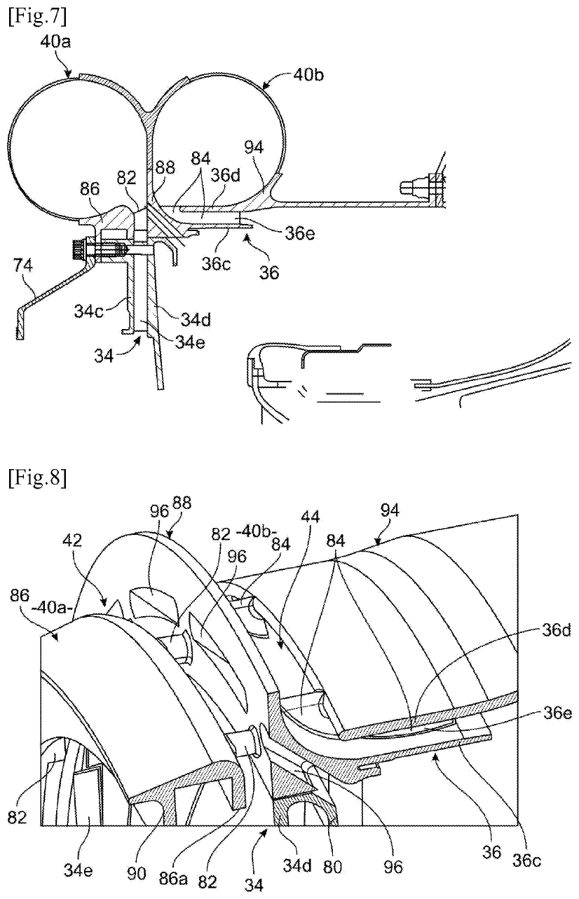

In the alternative embodiment illustrated in FIGS. 7 and 8, portions 86, 88 and 94 are also made in a single piece with the straightener 36.

The internal wall 36c of the straightener 36 is thus integrated with the intermediate portion 88, or more precisely the intermediate portion 88 comprises an annular upstream extension which forms the internal wall 36c of the straightener 36.

The vanes 36e are also an integral part of the portions 86, 88, 94. The vanes 36e can be at a distance from the arms 84 as in the previous embodiment. Alternatively, and as illustrated in the drawings, the arms 84 extend to between the walls 36c, 36d to form the vanes 36e.

In yet another embodiment not shown, the connecting arms 84 could be formed by the vanes 36e of the diffuser, which would also be formed in a single piece with the walls 36c, 36d and with the portions 86, 88, 94. The leading edges of the vanes 36e forming the connecting arms 84 would then be located further downstream than in the previous embodiments.

1. An aircraft turbine engine, comprising:
a compressor extending around an axis,
an annular combustion chamber extending around the axis A,
a system for diffusing and straightening an air stream exiting the compressor to supply the combustion chamber, this system comprising:
an annular diffuser comprising a substantially radially oriented outlet and an inlet supplied by the compressor, and
an annular straightener which comprises an outlet (36b) for supplying the combustion chamber, and
a heat exchanger this exchanger comprising:
+ a first circuit supplied with exhaust gas from the turbine engine, and
+ a second circuit comprising an inlet (38ba) connected by a first volute to the outlet of the diffuser, and an outlet connected by a second volute to an inlet of the straightener, the first and second volutes being placed side by side and each comprising an annular duct wound around the axis and connected to a first port located at the external periphery of the duct and oriented in the tangential direction, and a second port located at the internal periphery of the duct and defining an annular vein of air passage,
wherein the second port of each of the first and second volutes comprises connecting arms distributed around the axis, these connecting arms extending axially and/or radially through the vein of the second port and rigidly connecting annular portions of the first and second volutes which are attached or connected respectively to the diffuser and to the straightener.

2. The turbine engine according to claim 1, wherein the first volute comprises an upstream annular portion for attachment to the diffuser and/or to a first casing of the turbine engine, this upstream portion defining part of the duct and of the second port of this volute, first connecting arms extending axially through the vein of the second port of this volute from this upstream annular portion.

3. The turbine engine according to claim 2, wherein the upstream annular portion of the first volute comprises an annular flange for example radially internal, for attachment to the diffuser and/or to the first casing, for example by screw-type elements.

4. The turbine engine according to claim 1, wherein the first and second volutes share an intermediate annular portion which defines part of the duct and second port of each volute, said first connecting arms extending axially through the vein of the second port of the first volute to said intermediate annular portion.

5. The turbine engine according to claim 4, wherein the intermediate annular portion comprises air passage channels which are distributed around the axis and which each comprise a first end opening into the first volute, and a second end opening downstream of the diffuser.

6. The turbine engine according to claim 5, wherein the air passage channels are inclined from upstream to downstream radially inwards relative to the axis, and are at least partly surrounded by the second volute.

7. The turbine engine according to claim 1, wherein the second volute comprises a downstream annular portion for attachment to the straightener and/or to a second casing of the turbine engine, this downstream portion defining part of the duct and of the second port of this volute.

8. The turbine engine according to claim 7, wherein the downstream annular portion of the second volute comprises an annular flange for attachment to the diffuser and/or to the second casing, by screw-type elements for example.

9. The turbine engine according to claim 7, in dependence on one of claims 4 to 6, wherein second connecting arms extend axially through the second port of the second volute from the intermediate portion to the downstream portion.

10. The turbine engine according to claim 7, in dependence on one of claims 4 to 6, wherein the intermediate and downstream portions are formed in a single piece with the straightener, of the vanes of this straightener forming second connecting arms between these portions.

11. The turbine engine according to claim 1, wherein the parts of the ducts defined by said annular portions have greater thicknesses than the rest of these ducts.

12. The turbine engine according to claim 1, wherein said annular portions are all formed in a single piece.

13. The turbine engine according to claim 1, wherein the number of connecting arms of each of the second ports is between 6 and 60, and preferably between 8 and 20.
